(19) United States
(12) Patent Application Publication
(10) Pub. No.: US 2003/0072280 A1
(43) Pub. Date: Apr. 17, 2003

(54) Method and system for variable rate acknowledgement for wireless communication protocols

(76) Inventors: William J. McFarland, Los Altos, CA (US); Andrew M. Davidson, San Jose, CA (US); Tao-Fei S. Ng, Fremont, CA (US)

Correspondence Address: PILLSBURY WINTHROP LLP, 1600 Tysons Boulevard, McLean, VA, 22102, US

(21) Appl. No.: 10/251,902

(22) Filed: Sep. 20, 2002

Related U.S. Application Data
(60) Provisional application No. 60/324,607, filed on Sep. 24, 2001.

(51) Int. Cl. H04Q 7/00

(52) U.S. Cl. 370/332

(57) ABSTRACT

Systems and methods to adapt the rate at which acknowledgements are transmitted between nodes in a wireless communication system are presented. The systems and methods enable an acknowledgement based wireless communication system to extend its range and capacity by adapting a rate at which acknowledgement packets are transmitted between nodes to match the available transmit power of the acknowledge transmitting node and the propagation environment of the wireless communication system.

This application claims the benefit of priority to U.S. Provisional Application Serial No. 60/324,607 filed Sep. 24, 2001.

### FIELD OF THE INVENTION

The present invention is directed to communication systems and networks and is particularly directed toward variable rate acknowledgement in wireless transmission and communication systems.

### BACKGROUND

In wireless communications, there is generally a trade-off between data rate and error rate, that is, the higher the data rate, the higher the error rate. In an acknowledge based data link, the failure of receiving an acknowledgement in response to the transmission of a data packet automatically causes a re-transmission of the original data packet. Thus, in cases where acknowledge based data links are employed, the reliability of the acknowledge can have a great impact on the performance of the data link. This is especially true when data flow primarily in one direction. For example, in a wireless local area network (LAN), data primarily flow from the access point to the mobile client stations of the network. Since the access point is generally capable of higher transmit power than the mobile client stations, it is natural for the access point to choose a higher rate to transmit data packets and to have the mobile client station acknowledge receipt of any data packets at a lower rate to maximize the chance of successfully completing the frame exchange.

The Institute of Electrical and Electronics Engineers (IEEE) has established a wireless local area network (LAN) standard, 802.11 (IEEE 802.11). The IEEE 802.11 standard outlines Media Access Control (MAC) and Physical Layer (PHY) specifications for wireless LANs. The specification of IEEE 802.11 addresses rates of data transmission in wireless LANs. The IEEE 802.11 specification mandates that an acknowledgement packet (ACK) should be transmitted at the highest possible PHY mandatory rate, which is equal to or lower than the data rate, or transmit rate, at which the data packet that the ACK is intended to acknowledge was originally sent.

In practice, this PHY rate mandate of the IEEE 802.11 specification is not satisfactory in all instances because, for example, a mobile client station that acknowledges receipt of a data packet may only be capable of transmitting an ACK at a much lower power than the access point or station that initiated the packet exchange. This results in a lower chance that the ACK will be received by the packet initiation point, thereby requiring retransmission of the data packet. This persistent need to retransmit data packets lowers the overall throughput of the wireless LAN network. Therefore, meeting this restriction of the IEEE 802.11 specification, that is, always transmitting an ACK at the highest possible PHY mandatory rate, has the potential to severely impact system performance.

Accordingly, it would be desirable to implement a system that transmits ACKs to destination nodes without unduly sacrificing system performance.

### SUMMARY

In one or more embodiments of the present invention, a wireless network communication system is disclosed that adapts the rate at which requested acknowledgement packets are sent from the data packet receiving device to the data packet sending device. In one embodiment, the data packet receiving device, which in turn will be the acknowledgement packet sending device, determines the acknowledgement packet transmission rate according to whether a reliable acknowledgement packet transmission is possible. Acknowledgement packet transmission reliability is determined using the acknowledgement packet sending device available transmit power and the propagation environment of the wireless communication system. If acknowledgement packet transmission is deemed reliable, then the acknowledgement packet transmit rate is set to the highest possible allowed transmit rate of a plurality of allowed transmit rates. If acknowledgement packet transmission is not deemed reliable, the acknowledgement packet transmit rate is set to the lowest possible allowed transmit rate of the plurality of allowed transmit rates. In another embodiment of the present invention, the wireless communication network system is an IEEE 802.11a compliant network with multiple mobile network stations and either with or without a static network access port.

### BRIEF DESCRIPTION OF THE DRAWINGS

The foregoing and other features, aspects, and advantages will become more apparent from the following detailed description when read in conjunction with the following drawings, wherein:

FIG. 1 is a diagram illustrating the structure of a first exemplary wireless communications network according to a presently preferred embodiment;

FIG. 2 is a diagram illustrating the structure of a second exemplary wireless communications network according to a presently preferred embodiment;

FIG. 3 is a block diagram illustrating a network device according to the exemplary networks of FIGS. 1 and 2;

FIG. 4 is a flow diagram illustrating a first exemplary acknowledgement transmit data rate decision structure according to a presently preferred embodiment; and

FIG. 5 is a flow diagram illustrating a second exemplary acknowledgement transmit data rate decision structure according to a presently preferred embodiment.

### DETAILED DESCRIPTION OF THE PRESENTLY PREFERRED EMBODIMENTS

The present invention will now be described in detail with reference to the accompanying drawings, which are provided as illustrative examples of preferred embodiments of the present invention.

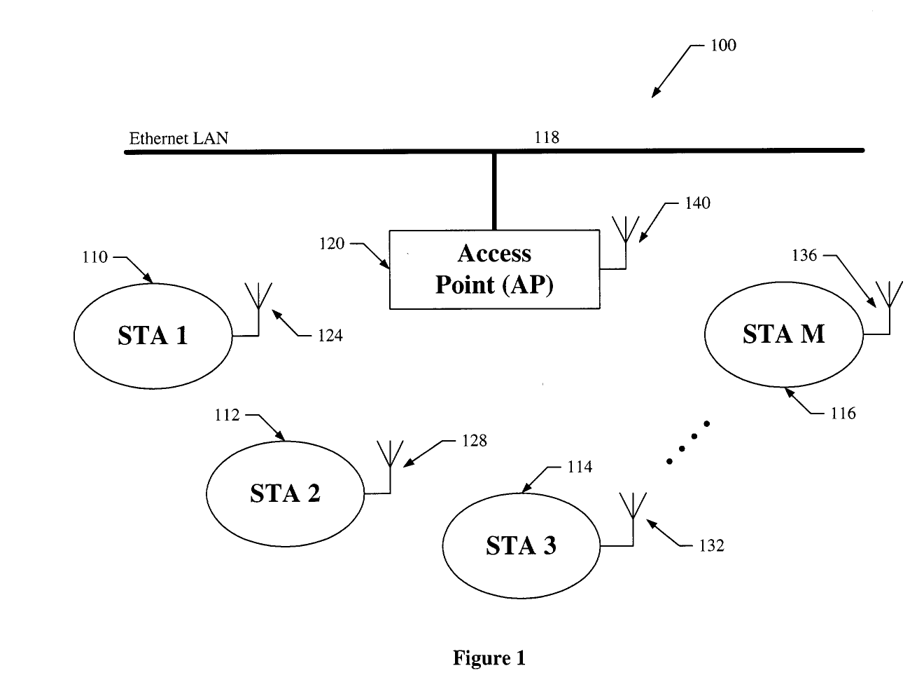

FIG. 1 is a diagram illustrating the structure of a first exemplary wireless networked communications system 100 that incorporates aspects of the presently preferred methods and systems described herein. In a presently preferred embodiment, the system 100 is preferably an 802.11a compliant wireless system. The system 100 includes several client devices, mobile nodes, or mobile stations (STA) STA 1 110, STA 2 112, STA 3 114, . . . , STA M 116, a base station or access point (AP) 120, and a wired network 118, for example, an Ethernet LAN, coupled to the AP 120. Each of the mobile stations 110, . . . , 116 and the AP 120 include one wireless transceiver, for example an antenna, for transmitting and receiving RF energy. The mobile stations (STA) STA 1 110, STA 2 112, STA 3 114, . . . , STA M 116 include antennas 124, 128, 132, 136 respectively and the AP 120 includes an antenna 140. Of course, the system 100 is not limited to one antenna per device, and any number of antennas may be used as suitable, subject to any technological, environmental, manufacturing, or performance limitations. The system 100 represents a Base Station System (BSS) network, or non-ad hoc network, because the wireless system 100 includes the AP 120. By contrast, an ad hoc network is a network without a centralized control device, such as a base station or an access point. In a BSS or non-ad hoc network configuration, a mobile station communicates solely with the access point, while the access point is configured to communicate with any and all of the mobile stations within its range of coverage. The AP 120 is a device that serves to interface the wireless network of mobile stations 110, . . . , 116 with the wired network 118, in this example, the Ethernet LAN. As shown in FIG. 1, multiple mobile stations 110, . . . , 116 may connect to the wired network via the same AP 120. A wireless communications system such as system 100 allows mobility, so that, unlike a conventional wired network, users or mobile stations such as mobile stations 110, . . . , 116 are permitted to move around while remaining connected to the wired network via the AP 120.

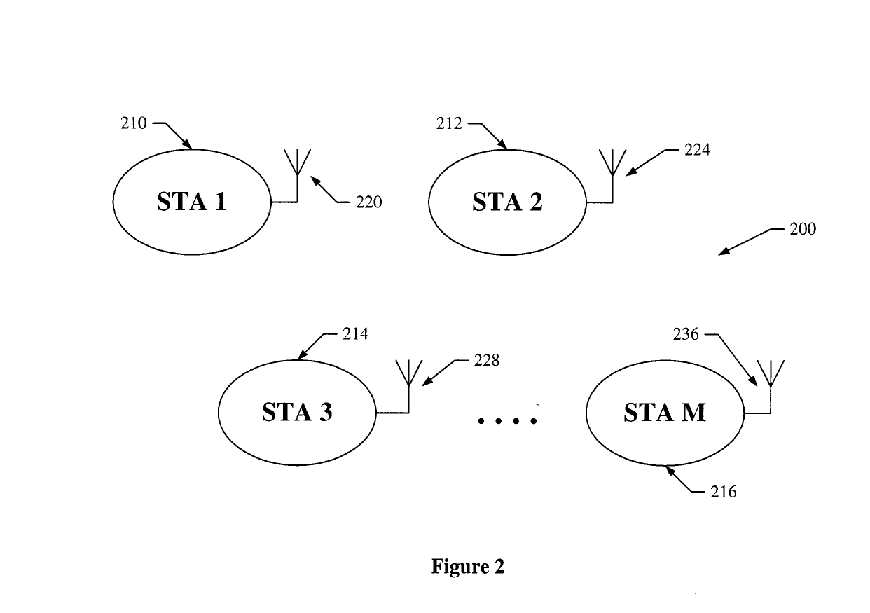

FIG. 2 is a diagram illustrating the structure of a second exemplary wireless networked communications system 200 that incorporates aspects of the presently preferred methods and systems described herein. In a presently preferred embodiment, the system 200 is preferably an 802.11a compliant wireless system. The system 200 includes several client devices, mobile nodes, or mobile stations (STA) STA 1 210, STA 2 212, STA 3 214, . . . , STA M 216. Each of the mobile stations 210, . . . , 216 include one wireless transceiver, for example an antenna, for transmitting and receiving RF energy. The mobile stations (STA) STA 1 210, STA 2 212, STA 3 214, . . . , STA M 216 include antennas 220, 224, 228, 232 respectively. Of course, the system 200 is not limited to one antenna per device, and any number of antennas may be used as suitable, subject to any technological, environmental, manufacturing, or performance limitations. Contrasting this exemplary system 200 with the system 100 of FIG. 1, the system 200 represents an Independent Basic Service Set (IBSS) network, or ad hoc network, because the wireless system 200 includes only the mobile stations 210, . . . , 216 and does not include a base station an access port. An ad hoc network is a network without a centralized control device, such as an access point. In this configuration, the mobile stations, such as mobile stations 210, . . . , 216, are permitted to communicate with one another directly.

A directed or unicast packet refers to a packet that is sent directly to a specific destination and thus typically requires an acknowledgement from the destination that uniquely receives the packet. This is in contrast to broadcast and multicast packets, which are sent to multiple destinations and typically do not require acknowledgements from any of the various destinations.

In some systems, a request to send (RTS) packet is sent from a source to a destination to ask the destination whether the source can send a packet. If the destination successfully receives the RTS packet and a send is acceptable, the destination responds with a clear to send (CTS) packet. The source can then send a data packet, typically a unicast data packet, to the destination. The source is then sent an acknowledgement packet from the destination if the unicast data packet is received successfully by the destination.

As a user or mobile station moves physically away from an access point such as the AP 120 in the BSS (non-ad hoc) network, or as the physical distance between mobile stations increases in an ad hoc network, the probability of a failed transmission between the mobile stations increases. The signals to and from the access point or between the mobile stations, as applicable, become weaker and packets are more likely to be received in error or lost due to noise.

In the case of a failed transmission of a packet, the mobile station or access point from which the packet originated can resend the packet. In some cases, the mobile station or access point may resend the packet at a lower data rate than the original transmission data rate to increase the probability that the packet is received correctly.

In the case of the BSS (non-ad hoc) system 100, the AP 120 sends broadcast packets to all of the mobile stations 110, . . . , 116. The mobile stations 110, . . . , 116 in the system 100 do not send packets of any type to one another and do not send broadcast packets to the AP 120, nor do the mobile stations 110, . . . , 116 send acknowledgement packets in response to broadcast packets received from the AP 120. Rather, the AP 120 and the mobile stations 110, . . . , 116 transmit unicast packets to each other. The AP 120 is preferably configured to return an acknowledgement packet in response to every unicast packet received at the AP 120. Similarly, the mobile stations 110, . . . , 116 are preferably configured to return acknowledgement packets in response to every unicast packet received at the mobile stations 110, . . . , 116.

In the case of the IBSS (ad hoc) system 200, there is no access point, only the mobile stations 210, . . . , 216. Any of the mobile stations 210, . . . , 216 may send broadcast packets to all of the other mobile stations 210, . . . , 216. During the intervals between beacon broadcast packets, any of the mobile stations 210, . . . , 216 may send unicast packets to any of the other mobile stations 210, . . . , 216. In contrast, then, to the BSS (non-ad hoc) network, the mobile stations 210, . . . , 216 in the system 200 do send packets to one another. The mobile stations 210, . . . , 216 do not send acknowledgement packets in response to broadcast packets. Rather, the mobile stations 210, . . . , 216 transmit unicast packets to each other. The mobile stations 210, . . . , 216 are preferably configured to return acknowledgement packets in response to every unicast packet received at the mobile stations 210, . . . , 216.

The exemplary wireless communication systems 100 of FIG. 1 and 200 of FIG. 2 both embody aspects of the presently preferred method and systems described herein. The methods and systems will be described with reference to the exemplary systems 100, 200. Preferably, any mobile station or access point such as those of wireless systems 100 and 200 can assume the position of a source transmitter or a destination receiver. For example, the access point AP 120 of system 100 in FIG. 1 is capable of acting as a source transmitter to transmit packets to the destination node mobile stations 110, . . . , 116 in accordance with the presently preferred embodiments described herein. Similarly, for example, the mobile station STA 3 114 of the system 100 in FIG. 1 is capable of acting as a source transmitter to transmit data packets to the destination AP 120 in accordance with the presently preferred embodiments described herein. Likewise, the mobile station STA 2 212 of the system 200 in FIG. 2, for example, is capable of acting as a source transmitter to transmit data packets to destination node mobile stations STA 1 210, STA 3 214, . . . , STA M 216 in accordance with the presently preferred embodiments described herein.

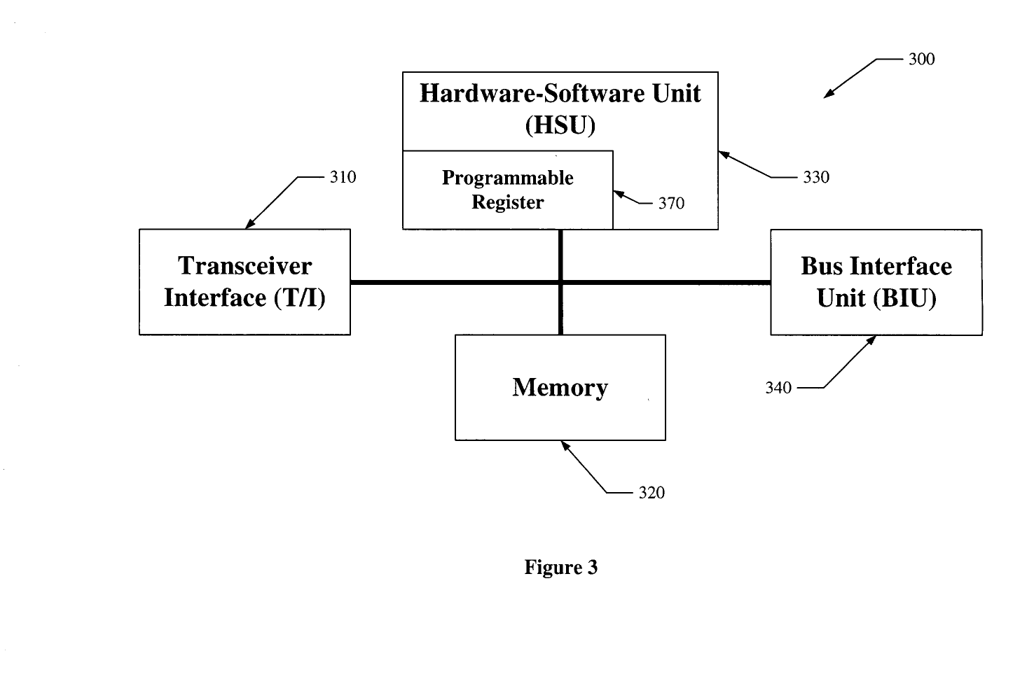

FIG. 3 is a block diagram illustrating an exemplary network device 300, such as an access point or a mobile station, according to a presently preferred embodiment. In a preferred embodiment, the network device 300 is an IEEE 802.11a compliant device. The network device 300 includes a transceiver interface (T/I) 310, a memory 320, a bus interface unit (BIU) 340, and a combined hardware/software unit (HSU) 330. The HSU 330 transfers packets from the BIU 340 into the memory 320. In addition, the HSU 330 queues packets for the T/I 310 so that the HSU 330 preferably controls the order in which packets are sent. The T/I 310 preferably includes one or more wireless transceivers for transmitting and receiving RF energy. In a presently preferred embodiment, the HSU 330 of the network device 300 includes control logic such as, for example, a programmable register 370, to manage acknowledgement transmit rates at the T/I 310 as described in more detail below. Although the programmable register 370 is illustrated in FIG. 3, in other embodiments the HSU 330 does not include a programmable register.

Describing the network device 300 with respect to the systems 100, 200, the device 300 represents any of the AP 120, the mobile stations 110, . . . , 116 of FIG. 1, and the mobile stations 210, . . . , 216 of FIG. 2.

Referring again to FIG. 3, depending on the implementation, the HSU 330 may be used in place of a conventional local processing unit and may partition some of the functions and features of the conventional local processing unit between hardware and software. The HSU 330 may also include functionality of a main host processor, if present on the network device 300. For example, an access point generally includes a processor, while a mobile station, depending on the implementation, may not include a processor but rather might include a dedicated hardware chip. For example, in a PCMCIA card implementation for a laptop or other device, the card typically does not include a processor.

The software portion of the HSU 330 in FIG. 3 preferably includes a software device driver that executes on the network device 300. Preferably, the device driver of the HSU 330 creates transmit and receive descriptors for the processing of packets. The transmit and receive descriptors are HSU 330 software/hardware additions to packets in order to assist the HSU 330 hardware with the processing of packets. Preferably, each packet to be sent by the T/I 310 has at least one corresponding transmit descriptor. A transmit descriptor describes all or part of a particular packet to be sent so that the packet may be sent into the network. Similarly, each packet received by the T/I 310 preferably has at least one corresponding receive descriptor. A receive descriptor describes all or part of a particular packet received so that the packet may be processed by the network device 300, and more particularly by the HSU 330. A description and explanation of the operation of the packet transmit descriptors is beyond the scope of this description and is not presented here so as not to distract from the central concepts herein presented.

The Hardware/Software Unit (HSU) 330

In a presently preferred embodiment, the HSU 330 performs a variety of functions. The HSU 330 implements ACK transmit rate management techniques, transfers packets from the BIU 340 into the memory 320, determines whether a transmission of a packet was successful, or whether a packet was received successfully, generates interrupts at the T/I 310, and requeues, manipulates, and stores packets in the memory 320. Several tasks and functions are preferably assigned to one or the other of the hardware and software portions of the HSU 330. For example, in a presently preferred embodiment, the HSU 330 software device driver that executes on the network device 300 can queue packets, or form a queue of packets for transmission. The HSU 330 software device driver preferably can control the order in which packets are sent and decide whether to send packets. The HSU 330 software device driver preferably can requeue, discard, manipulate, or store packets in memory for later processing. The HSU 330 software device driver preferably can create transmit and receive descriptors, and set or clear the value of a field, for example a bit value, in a transmit descriptor. The transmit descriptor fields preferably contain instructions to assist the hardware with the processing of packets.

The HSU 330 hardware preferably can process, attempt to process, or transmit packets from a queue. The HSU 330 hardware preferably can analyze packets, including inspecting and examining the fields of a transmit descriptor corresponding to the packet, for example, to determine the rate at which packets should be transmitted to destination nodes. The HSU 330 hardware preferably can block or allow the transmission of packets to destination nodes.

In describing the operation of the network device 300, functions are attributed to the hardware and the software portions of the HSU 330. It will be understood by those skilled in the relevant art that other implementations are possible. For example, hardware may perform a function that herein is attributed to the HSU 330 software or to a device driver executing on the network device 300, for example. Similarly, software may perform a function that herein is attributed to the HSU 330 hardware.

Fields Values in the Transmit and Receive Descriptors

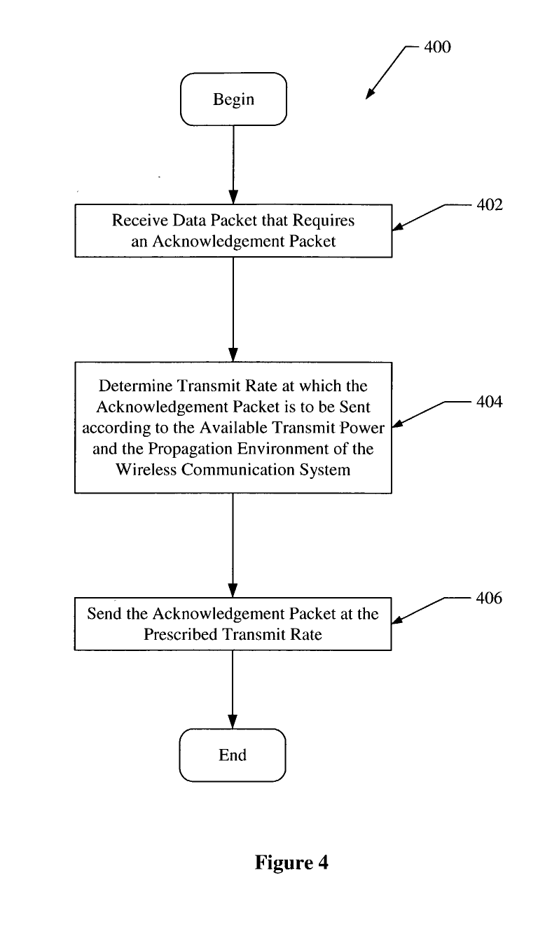

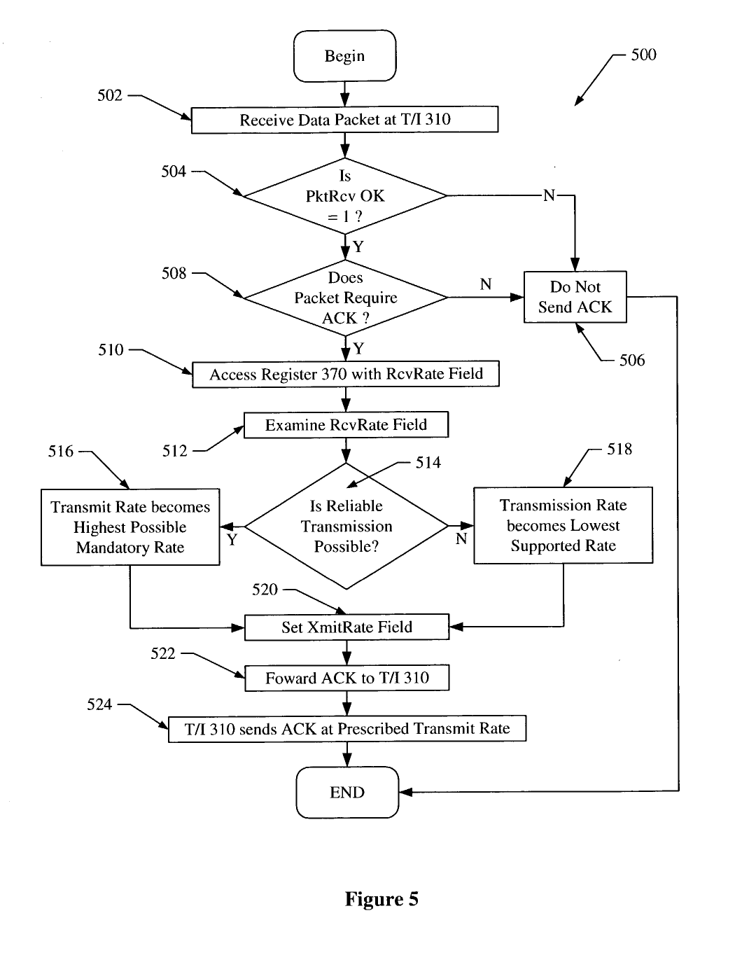

Preferably, every packet to be queued for the T/I 310 includes fields in one or more corresponding transmit descriptors to be utilized by the HSU 330 in processing packets according to the decision structures 400, 500 of FIGS. 4 and 5, respectively. Similarly, preferably every received packet to be processed by the HSU 330 includes fields in one or more corresponding receive descriptors. The transmit or receive descriptors are preferably updated to report completion status information.

Some examples of transmit descriptor fields in a presently preferred embodiment include the XmitRate field and the PktXmitOK field. Preferably, the XmitRate field specifies the rate at which a packet is to be transmitted. Preferably, the PktXmitOK field is a transmit descriptor completion status field value that preferably indicates whether packet transmission was successful.

Some examples of receive descriptor fields in a presently preferred embodiment include the RcvRate field and the PktRcvOk field, both completion status field values. Preferably, the RcvRate field specifies the rate at which a packet was received. Preferably, the PktRcvOK field of a receive packet indicates whether packet reception was successful. If set, for example, the packet was received successfully. If clear, for example, an error occurred during packet reception.

Exemplary Implementations of ACK Transmit Management

The operation of the network device 300 will now be described in more detail with reference to FIG. 4. FIG. 4 is a flow diagram illustrating a first exemplary ACK transmit rate management decision structure 400 according to a presently preferred embodiment and with respect to the device 300. At step 402, the device 300 receives a data packet such as a unicast packet that requires an acknowledgement packet. At step 404, the device 300 determines the transmit rate at which the acknowledgement packet is to be sent. Preferably, the determination of the transmit rate is based on the available transmit power of the device 300 and on the propagation environment of the wireless communication system. At step 406, the device 300 sends the acknowledgement packet to the node that sent the original data packet. The acknowledgement packet is sent at the transmit rate determined at step 404.

The presently preferred embodiment thus enables an acknowledgement based wireless communication system, such as the first and second exemplary wireless networked communications systems 100, 200, to extend its range and capacity by adapting a rate at which acknowledgement packets are transmitted between nodes to match the available transmit power of the transmitting nodes and the propagation environment of the wireless communication system.

Extended operation of the network device 300 according to a presently preferred embodiment will now be described in more detail with reference to FIG. 5. FIG. 5 is a flow diagram illustrating a second exemplary ACK transmit rate management decision structure 500 according to a presently preferred embodiment and with respect to the device 300. The decision structure 500 incorporates similar steps to those of the decision structure 400 of FIG. 4, but the decision structure 500 includes further processing steps to illustrate a more extended view of the operation of device 300 according to this presently preferred embodiment. Assume that the device 300 represents, for example, the mobile station STA 1 110 and that this station 110 communicates with the AP 120 of FIG. 1, although any device can be used for device 300 as suitable. The AP 120 sends a packet that does not require an acknowledgement, such as a broadcast packet, to the mobile station 110. At step 502, the packet is received at the T/I 310 of the mobile station 110. At step 504, the HSU 530 hardware examines the PktRcvOK field of the receive descriptor of the received broadcast packet. Assume that the broadcast packet is received correctly and that the PktRcvOK field is set. Processing advances to step 508, where the HSU 530 determines whether the packet requires an acknowledgement. Since the packet is a broadcast packet sent by the AP 120, the packet does not need an acknowledgement and processing advances to step 506, where the HSU 530 does not send an ACK to the AP 120.

Assume that the AP 120 next sends a data packet that requires an acknowledgement, such as a unicast packet, to the mobile station 110. At step 502, the packet is received at the T/I 310 of the mobile station 110. At step 504, the HSU 530 hardware examines the PktRcvOK field of the receive descriptor of the unicast packet. Assume that the unicast packet is received incorrectly and that the PktRcvOK field is clear. Processing advances to step 506, where the HSU 530 does not send an ACK to the AP 120. Rather, the AP 120 will most likely need to resend the unicast packet again to the mobile station 110.

Assume that the AP 120 next resends the unicast packet or sends a new data packet that requires an acknowledgement to the mobile station 110. At step 502, the packet is received at the T/I 310 of the mobile station 110. At step 504, the HSU 530 hardware examines the PktRcvOK field of the receive descriptor of the unicast packet. Assume that the unicast packet is received correctly and that the PktRcvOK field is set. Processing advances to step 508, where the HSU 530 determines whether the packet requires an acknowledgement. Since the packet is, for example, a unicast packet that does need an ACK, the mobile station 110 prepares to send an ACK and to determine the transmit rate at which the ACK will be sent to the AP 120.

Processing continues to step 510 where the HSU 530 accesses the programmable register 370 with the RcvRate field of the receive descriptor of the received unicast data packet being used as an input to the register 370. Generally, software is used to determine how the acknowledgement transit rate is selected. In the presently preferred embodiment, the HSU 530 software programmable register 370 is provided to select between at least two modes of ACK rate selection.

At step 512, the programmable register 370 examines the RcvRate field to obtain the receive rate of the received unicast data packet, that is, the rate at which the AP 120 sent the unicast data packet to the mobile station 110. At step 514, the register 370 determines whether reliable transmission is possible. In a presently preferred embodiment, the register 370 preferably determines whether reliable transmission is possible at the IEEE 802.11 compliant ACK transmit rate. The receive rate obtained at step 512 is important because the IEEE 802.11 compliant ACK transmit rate is specified as the highest possible PHY mandatory rate which is equal to or lower than the rate of the data packet that is to be acknowledged. For IEEE 802.11a, the PHY mandatory rates are 6, 12, and 24 Megabits per second (Mb/s). Of course, the methods and systems described herein are not limited to these allowable rates, and any allowable rates may be used as suitable and, as supported, consistent with other communication protocols.

In determining whether reliable transmission is possible, the network device 300 may consider any of a variety of factors, including overall wireless network and LAN conditions, the available transmit power of the device 300, the propagation environment of the wireless communication system in question, for example, wireless communication systems 100, 200, or more specifically, the propagation environment of the wireless communication link between the device 300, here the mobile station 110, and the other network device, here the AP 120, that sent the packet that requires acknowledgement.

If reliable transmission is possible, as determined by the HSU 330 programmable register 370, then at step 516 the ACK transmit rate becomes the highest possible mandatory rate, that is, the highest possible allowed transmit rate of the series of allowed or supported transmit rates, for example, the IEEE 802.11a compliant rate set of 6, 12, and 24 Mb/s.

If instead reliable transmission is not possible, as determined by the HSU 330 programmable register 370, then at step 518 the ACK transmit rate becomes the lowest supported rate, that is, the lowest possible allowed transmit rate of the series of allowed or supported transmit rates, for example, the lowest IEEE 802.11a compliant rate of 6 Mb/s.

Regardless of the ACK transmit rate that is selected by the software programmable register 370, processing continues to step 520. At step 520, the HSU 530 creates a transmit descriptor for the ACK packet that is to be sent and populates the XmitRate field in the transmit descriptor to the value of the ACK transmit rate determined in either step 516 or step 518. At step 522, the HSU 530 forwards the ACK packet to the T/I 310. At step 524, the T/I 310 of the network device 300, here the mobile station 110, sends the ACK packet at the prescribed transmit rate to the node that sent the original unicast packet, here the AP 120.

The presently preferred embodiment thus allows processing, implemented in, for example, software, at one node to choose between two modes of selecting the rate at which to transmit acknowledgement packets in order to maximize the probability of successful acknowledgement packet reception at another node at the opposite end of a wireless communication link. One mode is to let the acknowledgement packet rate track the rate of a received data packet in a manner compliant with IEEE 802.11. The other mode is to fix the acknowledgement packet rate to the lowest supported rate. The processing, for example software, can be implemented on, for example, a programmable register.

As used herein, the term network device is intended to refer broadly to the means of transmission as well as to the network entity housing the means of transmission and can encompass a variety of other transmission related features. In accordance with the presently preferred embodiments described herein, a network device can be, for example, an access point, a mobile station in a wireless network with an access point, or a mobile station in an wireless ad hoc network. The network device can be, for example, the device 300 of FIG. 3. The network device can be, for example, any of the AP 120 and the mobile stations 110, . . . , 116 of the system 100 shown in FIG. 1, or any of the mobile stations 210, . . . , 216 of the system 200 shown in FIG. 2. More broadly, a network device includes any IEEE 802.11 compliant device. Of course, the network device is not limited to wireless devices and wireless protocol and standard compliant devices, and the network device can encompass any device as suitable. A network device will often be a transceiver that is capable of both transmitting and receiving data in the form of electrical signals, for example, packetized data. The transceiver could include, for example, one or more physical antennas. In the broadest sense the transceiver may include RF and baseband units to convert raw data to and from electrical signals.

As used herein, the term transmit management interface is intended broadly to refer to a combination of hardware and software included with a network device and coupled or otherwise interfacing with transmissions means such as a transmitter, or a transceiver. For example, although in one embodiment the transmit management interface includes the HSU 330 of FIG. 3, other processors, processing arrangements, or software implementations, are possible. The transmit management interface may execute, for example, decision structures to adapt the ACK transmit rate in accordance with the methods described herein, such as in FIGS. 4 and 5, or the interface may utilize ACK transmit rate adaptation functionality external to the transmit management interface. The transmit management interface may include a programmable register or may access a programmable register external to the transmit management interface.

Of course, although the ACK transmit rate management systems and methods described herein according to the presently preferred embodiments are particularly well-suited for IEEE 802.11a compliant environments, the systems and methods may be applied to manage transmit rates operating at a wide variety of frequencies and in a wide range of environments.

The present invention can be implemented in digital electronic circuitry, or in computer hardware, firmware, software, or in combinations of them. Apparatus of the invention can be implemented in a computer program product tangibly embodied in a machine-readable storage device for execution by a programmable processor; and method acts of the invention can be performed by a programmable processor executing a program of instructions to perform functions of the invention by operating on input data and generating output data. The invention can be implemented advantageously in one or more computer programs that execute on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language. Suitable processors include, by way of example, both general and special purpose microprocessors, as well as other types of micro-controllers. Generally, a processor will receive instructions and data from a read-only memory and/or a random access memory. Generally, a computer will include one or more mass storage devices for storing data files; such devices include magnetic disks, such as internal hard disks and removable disks, magneto-optical disks, and optical disks. Storage devices suitable for tangibly embodying computer program instructions and data include all forms of non-volatile memory, including by way of example semiconductor memory devices, such as EPROM, EEPROM, and flash memory devices, magnetic disks such as internal hard disks and removable disks, magneto-optical disks, and CD-ROM disks. Any of the foregoing can be supplemented by, or incorporated in, application-specific integrated circuits (ASICs).

Although the present invention has been particularly described with reference to the preferred embodiments thereof, it should be readily apparent to those of ordinary skill in the art that changes and modifications in the form and details may be made without departing from the spirit and scope of the invention. For example, those skilled in the art will understand that variations can be made in the number and order of processing steps illustrated in the above flow diagrams and that variations can be made in the functional divisions between hardware and software. It is intended that the appended claims include such changes and modifications.

What is claimed is:

1. A method of adapting a rate at which acknowledgements are sent in a communication system, the method comprising:
sending a data packet at a first transmit rate from a first network device to a second network device, the data packet requesting an acknowledgement packet be sent from the second network device to the first network device;
receiving the data packet at the second network device;
determining if a reliable transmission is possible for the acknowledgement packet from the second network device to the first network device according to at least one of a plurality of factors;
setting a second transmit rate for the acknowledgement packet from a plurality of allowed transmit rates according whether the reliable transmission is possible; and
sending the acknowledgement packet at the second transmit rate from the second network device to the first network device.

2. The method of claim 1, wherein the communication system is an IEEE 802.11a compliant wireless communication system.

3. The method of claim 1, wherein one of the first network device and the second network device comprises an IEEE 802.11a compliant access point device, the IEEE 802.11a compliant access point device further connected to an Ethernet local area network.

4. The method of claim 1, wherein at least one of the first network device and the second network device comprises an IEEE 802.11a compliant mobile station device.

5. The method of claim 1, wherein the plurality of factors includes an available transmit power of the second network device and a propagation environment of the communication system.

6. The method of claim 1, wherein the plurality of allowed transmit rates includes 6, 12, and 24 Megabits per second.

7. The method of claim 1, wherein the second transmit rate is set to one of:
a highest possible allowed transmit rate of the plurality of allowed transmit rates if the reliable transmission is possible; and
a lower allowed transmit rate of the plurality of allowed transmit rates if the reliable transmission is not possible.

8. The method of claim 7, wherein the lower allowed transmit rate is a lowest possible allowed transmit rate of the plurality of allowed transmit rates.

9. A network device for adapting a rate at which acknowledgements are sent in a communication system, the network device comprising:
means for receiving a data packet sent at a first transmit rate from an other network device, the data packet requesting an acknowledgement packet be sent from the network device to the other network device;
means for determining if a reliable transmission is possible for the acknowledgement packet from the network device to the other network device according to at least one of a plurality of factors;
means for setting a second transmit rate for the acknowledgement packet from a plurality of allowed transmit rates according to whether the reliable transmission is possible; and
means for sending the acknowledgement packet at the second transmit rate from the network device to the other network device.

10. The method of claim 9, wherein the communication system is an IEEE 802.11a compliant wireless communication system.

11. The method of claim 9, wherein one of the network device and the other network device comprises an IEEE 802.11a compliant access point device, the IEEE 802.11a compliant access point device further connected to an Ethernet local area network.

12. The method of claim 9, wherein at least one of the network device and the other network device comprises an IEEE 802.11a compliant mobile station device.

13. The method of claim 9, wherein the plurality of factors includes an available transmit power of the network device and a propagation environment of the communication system.

14. The method of claim 9, wherein the plurality of allowed transmit rates includes 6, 12, and 24 Megabits per second.

15. The method of claim 9, wherein the second transmit rate is set to one of:
a highest possible allowed transmit rate of the plurality of allowed transmit rates if the reliable transmission is possible; and
a lower allowed transmit rate of the plurality of allowed transmit rates if the reliable transmission is not possible.

16. The method of claim 15, wherein the lower allowed transmit rate is a lowest possible allowed transmit rate of the plurality of allowed transmit rates.

17. A network device for adapting a rate at which acknowledgements are sent in a communication system, the network device comprising:
a transceiver interface, the transceiver interface being configured to:
receive a data packet sent at a first transmit rate from an other network device, the data packet requesting an acknowledgement packet be sent from the network device to the other network device; and
send the acknowledgement packet at a second transmit rate from the network device to the other network device; and
a transmit management interface, the transmit management interface being configured to:
determine if a reliable transmission is possible for the acknowledgement packet from the network device to the other network device according to at least one of a plurality of factors; and
set the second transmit rate for the acknowledgement packet from a plurality of allowed transmit rates according to whether the reliable transmission is possible.

18. The method of claim 17, wherein the communication system is an IEEE 802.11a compliant wireless communication system.

19. The method of claim 17, wherein one of the network device and the other network device comprises an IEEE 802.11a compliant access point device, the IEEE 802.11a compliant access point device further connected to an Ethernet local area network.

20. The method of claim 17, wherein at least one of the network device and the other network device comprises an IEEE 802.11a compliant mobile station device.

21. The method of claim 17, wherein the plurality of factors includes an available transmit power of the network device and a propagation environment of the communication system.

22. The method of claim 17, wherein the plurality of allowed transmit rates includes 6, 12, and 24 Megabits per second.

23. The method of claim 17, wherein the second transmit rate is set to one of:
a highest possible allowed transmit rate of the plurality of allowed transmit rates if the reliable transmission is possible; and
a lower allowed transmit rate of the plurality of allowed transmit rates if the reliable transmission is not possible.

24. The method of claim 23, wherein the lower allowed transmit rate is a lowest possible allowed transmit rate of the plurality of allowed transmit rates.

25. A wireless communication system, wherein the wireless communication system is a non-ad hoc system, comprising an access point and a mobile station, the mobile station including:
a transceiver interface, the transceiver interface being configured to:
receive a data packet sent at a first transmit rate from the access point, the data packet requesting an acknowledgement packet be sent from the mobile station to the access point; and
send the acknowledgement packet at a second transmit rate from the mobile station to the access point; and
a transmit management interface, the transmit management interface being configured to:
determine if a reliable transmission is possible for the acknowledgement packet from the mobile station to the access point according to at least one of a plurality of factors, the plurality of factors including an available transmit power of the mobile station and a propagation environment of the wireless communication system; and
set the second transmit rate for the acknowledgement packet from a plurality of allowed transmit rates according to whether the reliable transmission is possible, the second transmit rate being set to one of:
a highest possible allowed transmit rate of the plurality of allowed transmit rates if the reliable transmission is possible; and
a lowest possible allowed transmit rate of the plurality of allowed transmit rates if the reliable transmission is not possible.

26. A wireless communication system, wherein the wireless communication system is an ad hoc system, comprising a plurality of mobile station including a first mobile station and a second mobile station, the second mobile station comprising:
a transceiver interface, the transceiver interface being configured to:
receive a data packet sent at a first transmit rate from the first mobile station, the data packet requesting an acknowledgement packet be sent from the second mobile station to the first mobile station; and
send the acknowledgement packet at a second transmit rate from the second mobile station to the first mobile station; and
a transmit management interface, the transmit management interface being configured to:
determine if a reliable transmission is possible for the acknowledgement packet from the second mobile station to the first mobile station according to at least one of a plurality of factors, the plurality of factors including an available transmit power of the second mobile station and a propagation environment of the wireless communication system; and
set the second transmit rate for the acknowledgement packet from a plurality of allowed transmit rates according to whether the reliable transmission is possible, the second transmit rate being set to one of:
a highest possible allowed transmit rate of the plurality of allowed transmit rates if the reliable transmission is possible; and
a lowest possible allowed transmit rate of the plurality of allowed transmit rates if the reliable transmission is not possible.
